(19) United States
(12) Patent Application Publication
(10) Pub. No.: US 2010/0127962 A1
(43) Pub. Date: May 27, 2010

(54) Liquid Crystal Display Monitor

(76) Inventor: Ting-Yun Huang, Tainan County (TW)

Correspondence Address: NORTH AMERICA INTELLECTUAL PROPERTY CORPORATION, P.O. BOX 506, MERRIFIELD, VA, 22116, US

(21) Appl. No.: 12/277,306

(22) Filed: Nov. 25, 2008

(51) Int. Cl. G02F 1/1333; G09G 3/36

(52) U.S. Cl. 345/98; 349/58

(57) ABSTRACT

A liquid crystal display monitor includes a reception end for receiving image signals, a panel, a gate driver coupled to the panel, for driving the panel, a flexible printed circuit (FPC) coupled to the reception end, for transmitting the image signals, and a sequence of source drivers coupled to the panel and one of the source drivers coupled to the FPC, for outputting display data to the panel according to the image signals received from the FPC.

### BACKGROUND OF THE INVENTION

1. Field of the Invention

The present invention relates to a liquid crystal display monitor, and more particularly, to a liquid crystal display monitor including an only flexible printed circuit.

2. Description of the Prior Art

The advantages of a liquid crystal display (LCD) monitor include lighter weight, lower power consumption, and less radiation contamination. LCD monitors have been widely applied to various portable information products, such as notebooks, mobile phones, PDAs, etc. In an LCD monitor, incident light produces different polarization or refraction effects when the alignment of liquid crystal molecules is altered. The transmission of the incident light is affected by the liquid crystal molecules, and thus magnitude of the light emitted from the liquid crystal molecules varies. The LCD monitor utilizes the characteristics of the liquid crystal molecules to control the corresponding light transmittance and produces gorgeous images according to different magnitudes of red, blue, and green light.

Please refer to FIG. 1, which is a schematic diagram of an LCD monitor according to the prior art. The LCD monitor 1 0 includes a panel 1 00, a sequence of source drivers SD_1˜SD_n, a gate driver 106, a plurality of flexible printed circuits (FPC) F_1˜F_n. The panel 100 is constructed by two parallel substrates, and the liquid crystal molecules are filled between these two substrates. The FPCs F_1˜F_n are utilized for receiving image signals IMS_1˜IMS_n, and transmitting the image signals IMS_1˜IMS_n to the source drivers SD_1˜SD_n. Then, the source driver SD_1 controls the gate driver 106 to drive the panel 100, and the source drivers SD_1˜SD_n output display data to the panel 100 according to the image signals IMS_1˜IMS_n, to display images on the panel 100.

In FIG. 1, the number “n” is depended on design or the resolution of the LCD monitor 10. That is, as a size of the panel 100 becomes larger, the number “n” is increased, and the manufacturing cost of the LCD monitor 10 is also increased.

### SUMMARY OF THE INVENTION

It is therefore a primary objective of the claimed invention to provide a liquid crystal display monitor for decreasing the cost.

The present invention discloses a liquid crystal display monitor including a reception end for receiving image signals, a panel, a gate driver coupled to the panel, for driving the panel, a flexible printed circuit (FPC) coupled to the reception end, for transmitting the image signals, and a sequence of source drivers coupled to the panel and one of the source drivers coupled to the FPC, for outputting display data to the panel according to the image signals received from the FPC.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a liquid crystal display monitor according to the prior art.

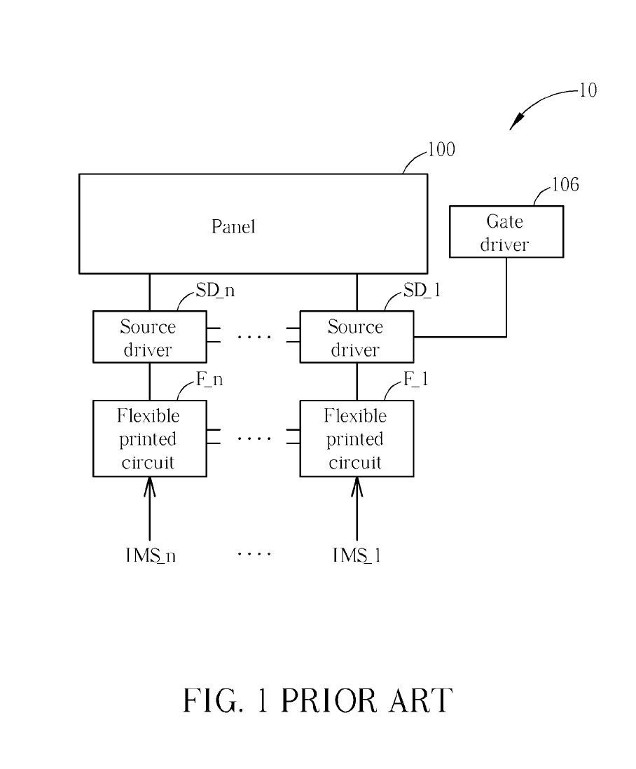

FIG. 2 is a schematic diagram of a liquid crystal display monitor according to an embodiment of the present invention.

FIG. 3 is a schematic diagram of a liquid crystal display monitor according to an exemplary embodiment of the present invention

### DETAILED DESCRIPTION

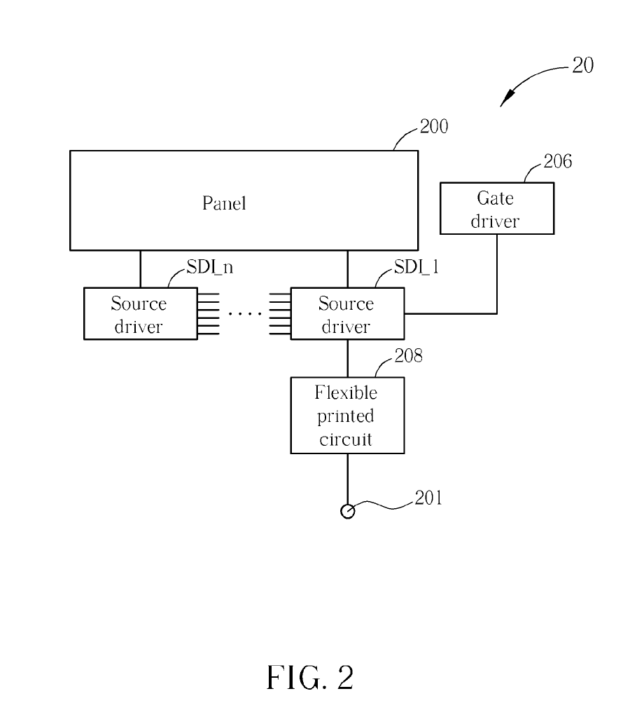

Please refer to FIG. 2, which is a schematic diagram of a liquid crystal display (LCD) monitor 20 according to an embodiment of the present invention. The LCD monitor 20 includes a panel 200, a reception end 201, a gate driver 206, a flexible printed circuit (FPC) 208, and a sequence of source drivers SDI_1˜SDI_n. The FPC 208 receives image signals via the reception end 201, and transmits the received image signals to the source driver SDI_1. The source drivers SDI_1˜SDI_n are utilized for outputting display data to the panel 100 according to the image signals received from the FPC 208, where the source driver SDI_1 can be regarded as a master source driver controlling the gate driver 206 to drive the panel 200.

The operation of the LCD monitor 20 is described as follows. The image signals are received by the reception end 201, and transmitted to the FPC 208. The FPC 208 transmits the image signals to the source driver SDI_1. Then the source driver SDI_1 controls the gate driver 206 to drive the panel 200, and transmits the image signals to the source driver SDI_2˜SDIsequentially. Finally, the source drivers SDI_1˜SDI_n output display data to the panel 200 according to the image signals.

As shown in FIG. 2, only the source driver SDI_1 is coupled to the FPC 208. That is, the LCD monitor of the present invention only needs one FPC to receive the image signals, such that the manufacturing cost can be reduced.

Note that, the FIG. 2 is utilized to show the embodiment of the present invention, and those skilled in the art can make modifications and alternations accordingly. For example, the source drivers SDI_1˜SDI_n can be coupled in a sequence via indium tin oxide (ITO) lines.

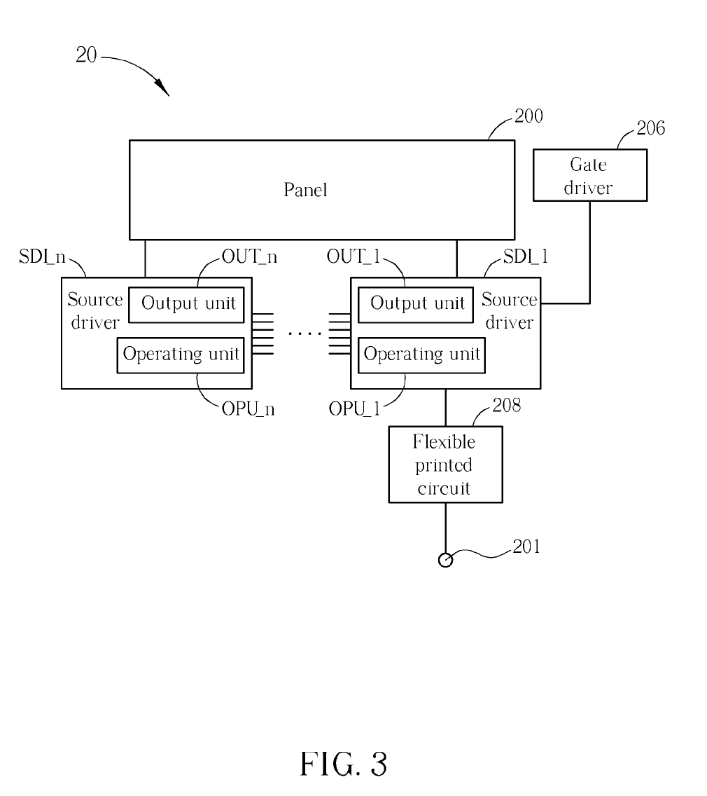

In addition, in order to decrease toggle rate in the ITO lines between the sequence of the source drivers SDI_1˜SDI_n, and to reduce noise for enhancing the image quality of the LCD monitor 20, the present invention further provides an embodiment as shown in FIG. 3. In FIG. 3, each of the source drivers SDI_1˜SDI_n include an operating unit (OPU_1˜OPU_n) and an output unit (OUT_1˜OUT_n). Each of the operating units OPU_1˜OPU_n is utilized for calculating a number of data variance between adjacent image signals of the image signals, to generate a calculation result. Each of the output units OUT_1˜OUT_n is coupled to a corresponding operating unit, and utilized for determining to reverse the later image signal of a certain length of image signals according to the calculation result, wherein the certain length can be determined by design purpose.

For example, when a calculation result indicates that the number of data variance within a certain length of image signals is greater than a predefined value, the corresponding output unit reverses the later image signal of the certain length of the image signals. The predefined value described above is preferably equal to a half of data amount of the certain length of the image signals. In addition, each of the output units OUT_1˜OUT_n is further utilized for transmitting an indication signal to the next source driver, to indicate a reverse status of the later image signal. For example, suppose the data amount of the image signals is 18 bits (combination of R/G/B). When the source driver SDI_1 receives image signals, the operating unit OPU_1 of the source driver 202 calculates data variance between the adjacent image signals, and generates a calculation result which indicates the number of data variance is greater than 9 bits. Then, the output unit OUT_1 transmits later image signals with an indication signal to the source driver SDI_2, to notify the next source driver SDI_2 that the later image signal is reversed. Oppositely, if the number of data variance is not greater than 9 bits, the output unit OUT_1 of the source driver SDI_1 only transmits later image signals to the source driver SDI_2; that is, the later image signal is not reversed. By the same token, the image signals are transmitted to the last source driver SDI_n. Since the image signals can be reversed when data variance between the adjacent image signals is greater than a predefined value, the present invention can decrease toggle rate in the ITO lines between the source drivers SDI_1˜SDI_n, and reduce noise, in order to enhance the image quality of the LCD monitor 20.

Moreover, the indication signal can be carried by any existed signal, such as a data signal, a start-up signal (DIO), a polarity control signal (POL), a data load signal (LD), or a clock signal (CLK).

In the prior art, the number of source drives equals the number of FPCs, causing the manufacturing cost increasing, especially when the size of the LCD panel becomes larger. In comparison, the present invention utilizes one FPC, so there is only one FPC cost, and the manufacturing cost of the LCD monitor can be dramatically decreased.

In conclusion, the present invention utilizes a single FPC to reduce the number of the FPC, so as to decrease the cost of the LCD monitor. In addition, the present invention can timely reverse image signals, to decrease the toggle rate and noise, and enhance the image quality of the LCD monitor.

Those skilled in the art will readily observe that numerous modifications and alterations of the device and method may be made while retaining the teachings of the invention.

What is claimed is:

1. A liquid crystal display monitor comprising:
a reception end for receiving image signals;
a panel;
a gate driver coupled to the panel, for driving the panel;
a flexible printed circuit (FPC) coupled to the reception end, for transmitting the image signals;
a sequence of source drivers coupled to the panel and one of the source drivers coupled to the FPC, for outputting display data to the panel according to the image signals received from the FPC.

2. The liquid crystal display of claim 1, wherein the sequence of source drivers are coupled in a sequence via indium tin oxide (ITO) lines.

3. The liquid crystal display of claim 1, wherein each of the source drivers comprises:
an operating unit for calculating a number of data variance between adjacent image signals of the image signals, to generate a calculation result; and
an output unit coupled to the operating unit, for determining whether to reverse the later image signal of the adjacent image signals according to the calculation result.

4. The liquid crystal display of claim 3, wherein the output unit reverses the later image signal when the calculation result indicates that the number of data variance between the adjacent image signals is greater than a predefined value.

5. The liquid crystal display of claim 4, wherein the predefined value equals a half of data amount of the adjacent image signals.

6. The liquid crystal display of claim 3, wherein the output unit is further utilized for transmitting an indication signal to a next source driver of the source drivers, to indicate a reverse status of the later image signal.

7. The liquid crystal display of claim 6, wherein the indication signal is carried by a data signal, a start-up signal (DIO), a polarity control signal (POL), a data load signal (LD), or a clock signal (CLK).
